(19) United States
(12) Patent Application Publication
(10) Pub. No.: US 2002/0030680 A1
(43) Pub. Date: Mar. 14, 2002

(54) Method and system for generating a three-dimensional object

(75) Inventors: Werner Knebel, Kronau (DE); Juergen Hoffmann, Wiesbaden (DE)

Correspondence Address: Simpson, Simpson & Snyder, L.L.P., 5555 Main Street, Williamsville, NY, 14221, US

(73) Assignee: Leica Microsystems Heidelberg GmbH, Mannheim (DE)

(21) Appl. No.: 09/871,336

(22) Filed: May 31, 2001

(30) Foreign Application Priority Data
Jun. 5, 2000 (DE) 100 27 323.8

(51) Int. Cl. G06T 15/50; G06T 15/60

(52) U.S. Cl. 345/426

(57) ABSTRACT

The present invention concerns a method for generating a three-dimensional object from a three-dimensional object model, the object model being scanned with a light beam of a light source and the light returning from the object model being detected. The object model is to be scannable with increased resolution and accuracy so that an object can be generated from the object model in a manner largely faithful to the model. The method according to the present invention is characterized in that the scanning optical system operates confocally.

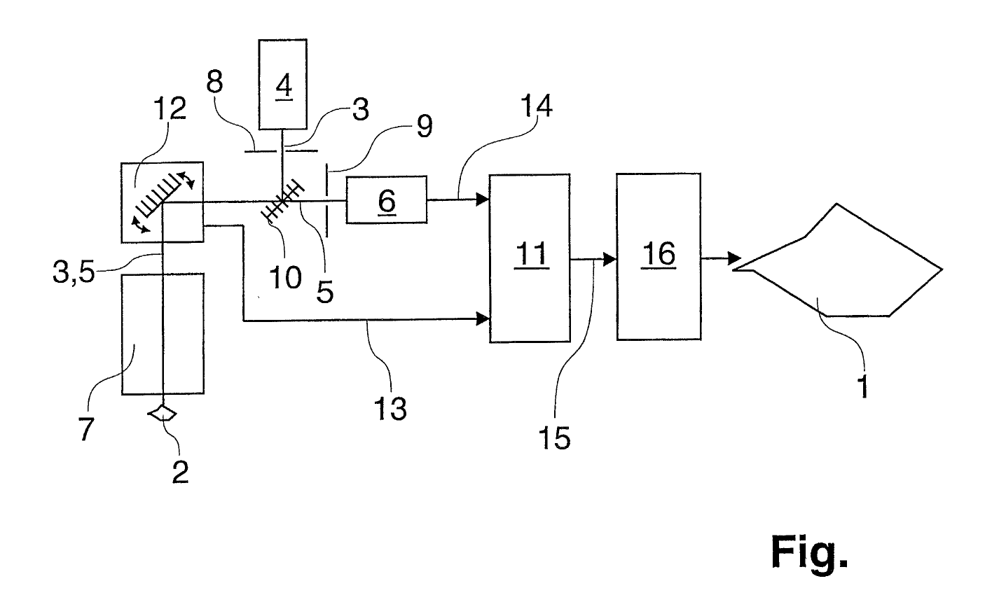

### CROSS REFERENCE TO RELATED APPLICATIONS

This application claims priority of the German patent application 100 27 323.8 filed Jun. 5, 2000 which is incorporated by reference herein.

### FIELD OF THE INVENTION

The present invention concerns a method and a system for generating a three-dimensional object from a three-dimensional object model.

### BACKGROUND OF THE INVENTION

Methods of the generic type have been known from practical use for some time. For example, three-dimensional object models are measured by means of the pattern projection method, so that on the basis of the recorded image data, a three-dimensional object can be generated from a three-dimensional object model.

In the pattern projection method, the object model is illuminated, for example, with a stripe pattern, and the illuminated object is detected with one or with several cameras. Based on computational reconstruction and analysis methods, conclusions can be drawn as to the shape and thus the spatial coordinates of the three-dimensional object model.

The generic methods are, however, limited in terms of resolution by the image acquisition operation. The achievable resolution depends on the nature, fineness, and quality of the pattern projected onto the three-dimensional object model, its orientation, the transfer function of the imaging optical system, and the number of object model images that are acquired. With regard to the computational analysis methods, the large depth of field of the imaging optical system creates particular problems, since the spatial coordinates of the three-dimensional object model must be extracted from the acquired projected two-dimensional object model images with high accuracy in the direction perpendicular to the projection plane as well, i.e. along the optical axis.

### SUMMARY OF THE INVENTION

It is therefore the object of the present invention to describe a method for generating a three-dimensional object with which an object model can be scanned with increased resolution and accuracy, so that an object that is largely faithful to the model can be generated from the object model.

The method according to the present invention of the generic kind achieves the aforesaid object way of the features of claim 1.

The aforesaid object is achieved by a method for generating a three-dimensional object comprising the steps of:

Scanning an object model with a light beam of a light source, wherein the scanning optical system operates confocally,

Detecting the light returning from the object model,

Generating object model data from the detected light and

Transmitting the object model data to an apparatus for object generation.

A further object of the invention is to create a system for generating a three-dimensional object with which an object model can be scanned with increased resolution and accuracy, so that an object that is largely faithful to the model can be generated from the object model.

The aforesaid object is achieved by a system for generating a three-dimensional object comprising:

A scanning optical system for scanning an object model;

A detector detecting the light returning from the object model;

A processing unit generating object model data from the detected light and

An apparatus for object generation.

What has been recognized according to the present invention is firstly that an improvement in resolution when scanning a three-dimensional object model can be achieved, especially in the direction of the optical axis, by confocal imaging. In this context, in contrast to the pattern projection method in which an extended two-dimensional pattern is projected onto the three-dimensional object model, the object is scanned in point-like fashion with a focused light beam. According to the confocal principle, only the intensity of the light of that point-like illuminated region returning from the object is measured; light from regions outside the focal plane of the imaging optical system is suppressed. The three-dimensional object data are obtained by confocal scanning of the three-dimensional object model. For that purpose, generally the illumination point is moved in meander fashion over the object in the focal plane of the imaging optical system, so that a two-dimensional sectional image of the object is thereby measured. That operation is successively repeated while the object distance from the imaging optical system is changed each time, so that ultimately a plurality of two-dimensional sectional images of the three-dimensional object model are detected and stored.

In particularly advantageous fashion, confocal scanning of the three-dimensional object model allows the resolution to be increased almost arbitrarily. For that purpose, the imaging optical system is configured in such a way that the three-dimensional extension of the point-like illumination pattern is correspondingly small. The smaller the size selected for the point-like illumination pattern, the higher the achievable resolution. A correspondingly fine meander-shaped scanning pattern must be selected.

The resolution capability achievable with the confocal scanning procedure is limited only by the numerical aperture of the imaging optical system and by the wavelength of the light used, since ideally a diffraction-limited point-like image is present. This results in increased resolution especially along the optical axis, since (in accordance with the confocal imaging principle) only the object regions located at the focus of the illumination point are detected, and the regions outside that focal area are suppressed. The resolution capability for detection of the object model can be increased in particular by increasing the resolution along the optical axis (as compared to the two-dimensional pattern projection method), thereby making possible, in a manner according to the present invention, an almost optimal three-dimensional reproduction, faithful to the model, of the three-dimensional object model.

Confocal imaging is achieved by inserting at least one illumination pinhole and one detection pinhole in the optical beam path. The illumination pinhole and the detection pinhole are each in optically conjugated arrangement with respect to the object. The illumination pinhole constitutes a point-like light source; the detection pinhole acts as a point-like detector.

The scanning operation is controlled by a control device, and the light beam is deflected by a beam deflection device. The beam deflection device usually has at least one movably arranged mirror that deflects the light beam. The present status of the beam deflection device, i.e. for example the position of the movably arranged mirror, is transmitted to the control device so that the latter knows the actual beam position or scanning position as the scanning operation proceeds over time. On the basis of these status data or position data, an intensity value correspondingly measured at an illumination point of the object model is allocated to an image position value, and generally is stored on a data medium. Usually a galvanometer or a resonant galvanometer is used for each movably arranged mirror as the positioning element of the beam deflection device.

The light returning from the object model could be reflected light and/or scattered light and/or fluorescent light. Corresponding filters are therefore arranged in the optical beam path; in the case of fluorescent light detection, for example, these use a wavelength-selective (dichroic) beam splitter to block out of the detection beam path, or suppress, principally the exciting light reflected from the object model, so that only the fluorescent light is detected.

In a concrete method step, provision is made for the detected object model data to be processed using image processing algorithms. This processing can be accomplished using a computer. Suitable image processing algorithms are, preferably, object segmentation, surface rendering, and/or surface smoothing methods. Provision is made first for segmentation of the three-dimensional object model that is to be reproduced, based on the detected three-dimensional image data set. Then a calculation is performed of the surface of the segmented three-dimensional object model (surface rendering). The surface determined in this fashion can, if necessary, be further processed with a corresponding smoothing algorithm in order, for example, to compensate for calculation artifacts that occurred during surface determination.

It is then possible to transmit the processed object model data to the apparatus for object generation, with which the three-dimensional object is generated. Alternatively, the detected object model data could also be transmitted directly—without the application of image processing algorithms—to the apparatus for object generation. In this case the necessary data for generating the three-dimensional object must be yielded directly from the detected image data set.

Concretely, provision is made for the generated object to faithful in scale to the scanned object model. With confocal imaging, the resolution capability along the optical axis is different from the resolution capability perpendicular thereto, i.e. in the focal plane. The detected object image data thus have an extension or pixel size that corresponds to the resolution capability and is different depending on the spatial direction. This fact must be taken into account in terms of process, for which purpose the detected or processed object model data are correspondingly scaled. For many applications, provision is made for the generated object to be larger than the object model; a reduction in size of the scanned object model is also conceivable. In a concrete application, the scale has a value of 1; i.e. the generated object is the same size as the scanned object model.

With macroscopic object models in particular, it may be necessary to scan the object model from different directions. This is required especially when the object model is a non-transparent three-dimensional object. In this case only the surface portion of the object model facing toward the scanning optical system can be scanned with the confocal principle, so that surface data can be extracted only therefrom. The portion of the surface of the object model facing away from the scanning optical system cannot supply a surface signal, since the light beam cannot penetrate to that portion of the object model. The object model could, by analogy with tomographic imaging methods, be rotated about at least one axis relative to the scanning optical system. It is advisable in this context to rotate the object or the scanning optical system by the same angular increment in each case. Alternatively, the object model could be detected simultaneously from different directions with several scanning apparatuses.

In very particularly preferred fashion, the scanning of object models of microscopic magnitudes is accomplished with a confocal scanning microscope. All objects that are usually detected with a confocal scanning microscope are conceivable in this context as possible object models. This comprises in particular biological specimens, which are generally at least partly transparent.

Provision is made for object generation to be accomplished substantially by means of material-removing or non-material-removing shaping. Object generation could furthermore be accomplished substantially using laser beam lithography methods. In this context, the laser beam of the laser beam lithography machine could expose a polymer liquid that cures under laser light. Exposure of the curable polymer liquid could be accomplished by analogy with the scanning operation of the object model. First a scanned two-dimensional sectional image of the object model is exposed with the laser beam lithography machine, and then the next scanned sectional image is exposed with the laser beam lithography machine. In this context, the optical system of the laser beam lithography machine could also operate confocally. Very generally, rapid prototyping methods could be used for object generation.

Preferably object generation is accomplished almost simultaneously with scanning of the object model. The three-dimensional object that is to be generated could thus be present directly after the operation of scanning the object model, after the object model has been scanned and, almost simultaneously, the three dimensional object has been exposed with the laser beam lithography machine.

In particularly advantageous fashion, the generated object can be made of various materials. For example, the laser beam lithography machine could expose a mixture of various polymer liquids with laser light of different wavelengths. In this context, the laser light of the one wavelength may effectively cure only one polymer liquid, whereas the laser light of the other wavelength exposes and cures only the other polymer liquid. The generated object could accordingly be generated from various polymer materials.

In very particularly advantageous fashion, the generated object comprises transparent and/or partly transparent materials or object regions. This allows, in particular, transparent object regions of biological specimens that are detected with a confocal scanning microscope also to be reproduced transparently in a manner faithful to the model. A partly transparent generation of the object is also conceivable. To achieve different degrees of transparency, a corresponding polymer liquid that generates a cured material with different degrees of transparency as a function of exposure time could be used in conjunction with the laser lithography machine. This generated three-dimensional object is then a reproduction of the microscopic object model that is faithful in terms of scale and optionally color and transparency. For research or teaching purposes in particular, the scientist or student can directly examine the actual physical configuration of the object and the arrangement of individual object regions with respect to one another, advantageously using the generated object, without the cumbersome manipulation of (pseudo-)three-dimensional depictions of the object on the computer monitor, optionally with stereoscopic glasses or other aids.

Especially in conjunction with confocal fluorescent scanning microscopy of biological object models, the generated object is produced in various colors. For example, an object labeled with three different fluorescent dyes can be reproduced in the colors that correspond to the characteristic wavelength of the fluorescent emission of the respective fluorescent dye. In this case as well, a laser beam lithography machine could be used to expose a corresponding mixture of polymer liquids with laser light of different wavelengths. In addition, the generated object itself could be equipped with fluorescent and/or phosphorescent materials.

Very generally, provision is made for the generated object to be generated from various materials and/or for the materials to have a different transparency and/or a different color. In this context, the object can be configured as a function of the intensity value and/or wavelength and/or polarization of the detected object model light. For example, it is conceivable for the transparency of the material of the generated object to be correspondingly configured as a function of the intensity value of the detected object model light. The wavelength of the detected object model light could furthermore correspond to a corresponding color of the object being generated. Provision is made for the specification allocating the property of the detected object model light to the property of the generated object material configuration to be definable by a user.

The method according to the present invention could furthermore be used to depict dynamic processes of regions of the object model. For this purpose, an object line can be detected at different times. The detected object lines, i.e. a line of the object model, are then assembled into a surface object. The depiction of dynamic processes of an object plane, i.e. a plane of the object model, in similar fashion is conceivable. In this, an object plane or a sectional plane of the object model is detected at different times, and the time series thus obtained is assembled into a three-dimensional object. With both forms of depiction, one spatial axis corresponds to the time axis of the dynamic process.

### BRIEF DESCRIPTION OF THE DRAWINGS

There are various ways of advantageously embodying and developing the teaching of the present invention. The reader is referred, for that purpose, on the one hand to the claims subordinate to claim 1, and on the other hand to the explanation below of the preferred exemplary embodiments of the invention with reference to the drawings. In conjunction with the explanation of the preferred exemplary embodiments of the invention with reference to the drawings, an explanation is also given of generally preferred embodiments and developments of the teaching. In the drawings, the single Figure is a schematic depiction of a confocal scanning microscope for carrying out the method according to the present invention.

### DETAILED DESCRIPTION OF THE INVENTION

The Figure shows a confocal fluorescent scanning microscope for carrying out the method for generating a three-dimensional object 1 from a three-dimensional object model 2. Object model 2 is scanned with a light beam 3 of a light source 4. Fluorescent light 5 returning from object model 2 is detected with detector 6.

According to the present invention, scanning optical system 7, 8, and 9 operates confocally. For this purpose, an illumination pinhole 8 is arranged in the illumination beam path of light source 4, optically conjugated with the object model-side focal plane of microscope objective 7 of the scanning optical system. Detection pinhole 9 is also arranged in optically conjugated fashion with respect to the object model-side focal plane of microscope objective 7. Illuminating light 3 reflected from object model 2 is separated, by means of a dichroic beam splitter 10, from fluorescent light 5 returning from object model 2, in such a way that only fluorescent light 5 can pass through dichroic beam splitter 10 and is detected by detector 6.

The scanning operation is controlled by a control device 11. Light beam 3, 5 is deflected by a beam deflection device 12. The beam deflection device is a gimbal-mounted mirror that deflects light beam 3, 5 sinusoidally in one direction and in a sawtooth shape in a direction orthogonal thereto, thus resulting in a meander-shaped object model scan in the focal plane of microscope objective 7.

The present status of beam deflection device 12, i.e. the instantaneous spatial position of the mirror, is transmitted to control device 11. Control device 11 thus knows the profile over time of the actual beam position during the scanning operation. Beam position data 13, as well as signal 14 detected by detector 6, are transmitted to control device 11 in analog form and digitized by control device 11.

Object model 2 is a biological specimen specifically labeled with two different fluorescent dyes. Light 5 returning from object model 2 is consequently fluorescent light.

The detected object model data 14 are processed by control device 11 using image processing algorithms. First the detected three-dimensional object model data set is segmented. This yields two classes of objects: on the one hand the objects specifically labeled on the one hand with the one fluorescent dye, and on the other hand those specifically labeled with the other fluorescent dye. The surfaces of the segmented objects are then determined with a further image processing algorithm (surface rendering). The processed object model data 15 are transmitted to apparatus 16 for object generation.

Apparatus 16 for object generation generates object 1 in faithfully scaled fashion from the scanned object model 2. It embodies a 200-times magnification of the object model, although this is not depicted at actual scale in the Figure.

Object generation is accomplished using laser beam lithography methods.

In conclusion, be it noted very particularly that the exemplary embodiments discussed above serve merely to describe the teaching claimed, but do not limit it to the exemplary embodiments.

### Parts List

| | |
|---|---|
| 1 | Generated object |
| 2 | Object model |
| 3 | Light beam |
| 4 | Light source |
| 5 | Light returning from (2) |
| 6 | Detector |
| 7 | Scanning optical system |
| 8 | Illumination pinhole |
| 9 | Detection pinhole |
| 10 | Dichroic beam splitter |
| 11 | Control device |
| 12 | Beam deflection device |
| 13 | Beam position data |
| 14 | Detected light intensity |
| 15 | Processed object model data |
| 16 | Apparatus for object generation |

What is claimed is:

1. A method for generating a three-dimensional object comprising the steps of:
Scanning an object model with a light beam of a light source, wherein the scanning optical system operates confocally,
Detecting the light returning from the object model,
Generating object model data from the detected light and
Transmitting the object model data to an apparatus for object generation.

2. The method as defined in claim 1, wherein the scanning optical system has at least one illumination pinhole and one detection pinhole.

3. The method as defined in claim 1, wherein the scanning operation is controlled by a control device, and the light beam is deflected by a beam deflection device.

4. The method as defined in claim 1, wherein the light returning from the object model is reflected light and/or scattered light and/or fluorescent light.

5. The method as defined in claim 1, wherein scanning of the object model is accomplished with a confocal scanning microscope.

6. The method as defined in claim 1, wherein object generation is accomplished substantially by material-removing shaping.

7. The method as defined in claim 1, wherein as a function of an intensity value and/or a wavelength and/or a polarization of the detected object model light, the generated object is generated from various materials.

8. The method as defined in claim 1, wherein in order to depict dynamic processes of an object plane, the object planes detected at different times are assembled into a three-dimensional object.

9. A method for generating a three-dimensional object comprising the steps of:
Scanning an object model with a light beam of a light source, wherein the scanning optical system operates confocally,
Detecting the light returning from the object model,
Generating object model data from the detected light and
Transmitting the object model data to an apparatus for object generation, wherein object generation is accomplished substantially using laser beam lithography methods.

10. The method as defined in claim 9, wherein the laser beam of the laser beam lithography machine exposes a polymer liquid that can be cured with laser light.

11. The method as defined in claim 9, wherein rapid prototyping methods are used for object generation.

12. The method as defined in claim 9, wherein as a function of an intensity value and/or a wavelength and/or a polarization of the detected object model light, the generated object is generated from various materials.

13. The method as defined in claim 9, wherein in order to depict dynamic processes of an object plane, the object planes detected at different times are assembled into a three-dimensional object.

14. A system for generating a three-dimensional object comprising:
A scanning optical system for scanning an object model;
A detector detecting the light returning from the object model;
A processing unit generating object model data from the detected light and
An apparatus for object generation.

15. The system of claim 14, wherein the scanning optical system has at least one illumination pinhole and one detection pinhole.

16. The system of claim 14, wherein the scanning operation is controlled by a control device, and the light beam is deflected by a beam deflection device.

17. The system of claim 14, wherein scanning optical system is a confocal scanning microscope.

18. The system of claim 14, wherein apparatus for object generation is a laser beam lithography machine.

19. The system of claim 18, wherein the laser beam of the laser beam lithography machine exposes a polymer liquid that can be cured with laser light.
